(19) United States
(12) Patent Application Publication
(10) Pub. No.: US 2017/0198206 A1
(43) Pub. Date: Jul. 13, 2017

(54) HIGH TEMPERATURE VISCOUS FLUID SYSTEMS IN HIGH SALINITY WATER

(71) Applicant: Trican Well Service, Ltd., Calgary (CA)

(72) Inventors: Sarkis R. Kakadjian, The Woodlands, TX (US); Jose Roberto Torres, JR., Spring, TX (US)

(73) Assignee: Trican Well Service, Ltd., Calgary (CA)

(21) Appl. No.: 14/993,120

(22) Filed: Jan. 12, 2016

(51) Int. Cl. C09K 8/68; C09K 8/88; C09K 8/90

(52) U.S. Cl. CPC C09K 8/68; C09K 8/90; C09K 8/882

(57) ABSTRACT

By adding a polyol to a viscosifying agent in water, where the water has a high concentration of salt, such as seawater or brine. The viscosifying agent tends to remain stable for a sufficient amount of time in the presence of downhole temperatures at and in excess of 300° F.

### BACKGROUND

Hydraulic fracturing is a common and well-known enhancement method for stimulating the production of hydrocarbon bearing formations. The process involves injecting fluid down a wellbore at high pressure. The fracturing fluid is typically a mixture of water and proppant. The proppant may be made of natural materials or synthetic materials.

Generally the fracturing process includes pumping the fracturing fluid from the surface through a tubular. The tubular has been prepositioned in the wellbore to access the desired hydrocarbon formation. The tubular has been sealed both above and below the formation to isolate fluid flow either into or out of the desired formation and to prevent unwanted fluid loss. Pressure is then provided from the surface to the desired hydrocarbon formation in order to open a fissure or crack in the hydrocarbon formation.

Typically large amounts of fluid are required in a typical hydraulic fracturing operation. Additionally, chemicals are often added to the fluid along with proppant to aid in proppant transport, friction reduction, wettability, pH control and bacterial control. Typically, the fluid is mixed with the appropriate chemicals and proppant particulates and then pumped down the wellbore and into the cracks or fissures in the hydrocarbon formation.

Due to the large amounts of fluid required in a typical hydraulic fracturing operation as well as the ecological implications many operators would prefer to utilize the water that is locally available. For instance in many regions it may be advantageous to use sea water, produced water, or brine as the base fluid during drilling or fracturing operations.

The base fluids for hydraulic fracturing fluid systems have historically been limited by the concentration of salts, typically sodium chloride. Operators have found that while certain hydraulic fracturing fluids systems may work in the presence of salt the efficacy of such systems diminishes as temperature increases. As pressure increases on the service companies and operators to find alternatives to the use of high quality water sources, such as fresh potable water, as the base fluid for their hydraulic fracturing operations, and as scrutiny is increasing over disposal practices for produced water and flowback, the pressure pumping marketing continues to pursue fracturing fluid additives or systems that will enable the use of water having higher concentrations of salts as the base fluid.

### SUMMARY

An alternative approach to enabling the use of certain hydraulic fracturing systems in the presence of salt and relatively high temperatures, ie temperatures above 260° F., is to add a polyol to the system. In particular it has been found beneficial to use a polyol such as propylene glycol, methanol, and even sugar alcohols to enhance the viscosity of a cross-linked polymeric viscosifier.

One embodiment is to stabilize the gel system by preventing the hydrolysis of the glycosidic linkage or the oxidative/reductive depolymerization where the free radicals are deviated from scission of the polysaccharide chain to attach the hydroxyl groups of the polyols by stabilizing the system either by scavenging oxygen in the polymers solutions with sodium thiosulfate among others.

The new approach includes adding polyols at concentrations up to 50 gallons per thousand to a cross-linked polymer viscosifier such as guar and derivatives, cellulose and derivatives and acrylamide polymer and copolymers with a zirconate cross-linker in order to improve the rheological profile at temperatures above 260° F. The polyols can include diols like ethylene and propylene glycol, triols like glycerol and other sugar alcohols like arabitol, manitol, sorbitol, xylitol etc.

### BRIEF DESCRIPTION OF THE DRAWINGS

FIG. 1 depicts the rheological profile of a fracturing fluid system having a viscosifier, a low pH buffer, a crosslinker, and propylene glycol in sea water at 300 degrees Fahrenheit.

FIG. 2 depicts rheological profile of a fracturing fluid system having a viscosifier, a low pH buffer, a crosslinker, and varying amounts of propylene glycol in sea water at 300 degrees Fahrenheit.

FIG. 3 depicts the rheological profile of a fracturing fluid system having a viscosifier, a low pH buffer, a crosslinker, and various amounts of polyols in sea water at 300 degrees Fahrenheit.

FIG. 4 depicts the rheological profile of a fracturing fluid system having a viscosifier, a low pH buffer, a crosslinker, and various amounts of polyols primarily sugars in sea water at 300 degrees Fahrenheit.

### DETAILED DESCRIPTION

The description that follows includes exemplary apparatus, methods, techniques, or instruction sequences that embody techniques of the inventive subject matter. However, it is understood that the described embodiments may be practiced without these specific details. Any references to sea water or brine, should be understood to include any salt laden water including sea water, produced water, and brine.

A viscosifying agent may be a cellulosic polymer including, but not limited to, carboxyalkyl cellulose or carboxyalkyl cellulose and may be crosslinked with transition metals like zirconate derivatives, titanate derivatives, and aluminate derivatives and combinations thereof.

Viscosifying agents may be guar and its derivatives including, but not limited to, carboxy alkyl guars, such as carboxy methyl hydroxy propyl guar, hydroxyl propoyl guar, and carboxy methyl guar. Other examples of such guars include, without limitation, xanthan, scleroglucan and Welan gums. Such viscosifiers may be crosslinked with borates, borate related crosslinkers, transition metals like zirconate derivatives, aluminate derivatives, and combinations thereof.

Viscosifying agents may be synthetic viscosifiers including, but not limited to, acrylic and acrylamide polymers and copolymers, polyvinyl alcohols, ester and polyether. Such viscosifiers may be crosslinked with borates, borates related crosslinkers, transition metals like zirconate derivatives, aluminate derivatives, and combinations thereof.

Viscosifying agents such as sulfonated gelling agents which may be any sulfonated synthetic polymers including, but not necessarily limited to sulfonated polyvinyl alcohol, sulfonated polyacrylate, sulfonated polyacrylamide, sulfonated galactomannan gums, sulfonated cellulose, acrylic acid copolymers or any combination thereof may be used.

A suitable crosslinking agent may be used with the viscosifiers where the crosslinking agent may be any compound that increases the viscosity of the fluid by chemical crosslinking, physical crosslinking, or any other mechanisms. For example, the gellation of a hydratable polymer can be achieved by crosslinking the polymer with metal ions including boron, zirconium, and titanium containing compounds, or mixtures thereof. One class of suitable crosslinking agents are organotitanates. Another class of suitable crosslinking agents are borates. Suitable crosslinking agents include, but are not limited to, zirconium triethanolamine complexes, zirconium acetylacetonate, zirconium lactate, zirconium carbonate, and chelants of organic alpha hydroxyl corboxylic acid and zirconium.

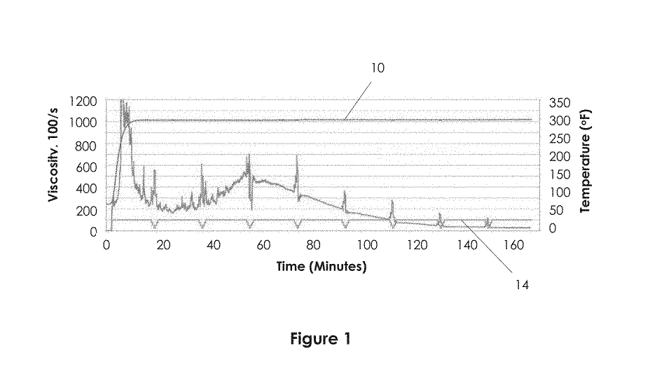

FIG. 1 depicts the rheological profile of a fracturing fluid system having a viscosifier in an amount of 40 pounds per thousand gallons of fluid (“PPT”) in sea water. In particular the viscosifying agent is a guar, more particularly carboxy methyl hydroxy propyl guar (“CMHPG”). Additional additives are a low pH buffer, in particular 0.2 gallons per thousand (“GPT”) of an aluminum acetate and acetic acid blend, 10.0 GPT propylene glycol, and 0.35 GPT of zirconium lactate in an isopropyl alcohol as a cross-linker. Line 10 charts the temperature of the fluid over the duration of the test. Line 12 is the graphical results of the viscosity over time and temperature test using the fluid described. Line 14 is the shear rate of the test over time. As can be seen the CMHPG maintained the viscosity of at least 100 centipoise for over about 110 minutes and maintain the viscosity over about 50 centipoise for about 130 minutes.

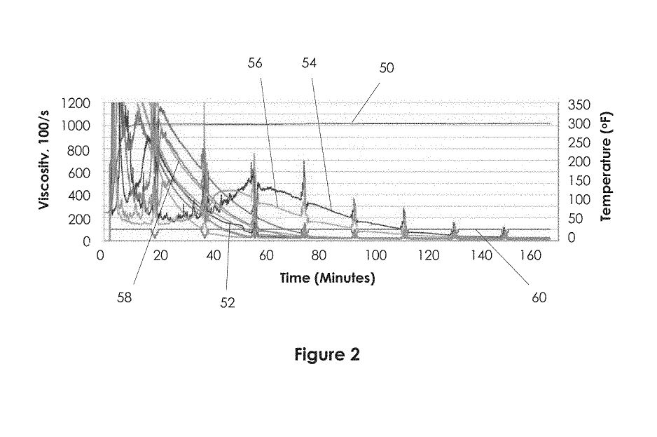

FIG. 2 depicts the rheological profile of a fracturing fluid system having a viscosifier in an amount of 40 PPT in sea water. The viscosifying agent is CMHPG. Additional additives are a low pH buffer, in particular 0.2 gallons per thousand (“GPT”) of an aluminum acetate and acetic acid blend and 0.35 GPT of zirconium lactate in an isopropyl alcohol as a cross-linker. In this chart the amount of the polyol propylene glycol is varied. Line 50 charts the fluid temperature over the duration of the test. Line 52 is the shear rate of the fluid having 0.0 GPT of added polyol over time. Line 54 is the shear rate of the fluid having 10.0 GPT of added polyol, propylene glycol, over time. Line 56 is the shear rate of the fluid having 25.0 GPT of added polyol, propylene glycol, over time. Line 58 is the shear rate of the fluid having 50.0 GPT of added polyol, propylene glycol, over time. Line 60 is the shear rate of the test over time. As can be seen the fluid having no polyol maintained a viscosity of greater than 50 centipoise for the least amount of time, about 68 minutes. The fluid having 10.0 GPT of polyol, propylene glycol, maintained a viscosity of greater than 50 centipoise for the longest amount of time, about 130 minutes. As the amount of polyol, propylene glycol, was further increased the fluid was able to maintain a viscosity of greater than 50 centipoise for shorter periods although still for longer periods than without a propylene glycol.

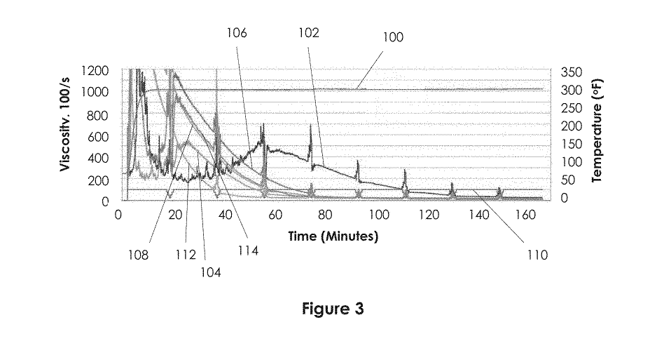

FIG. 3 depicts the rheological profile of a fracturing fluid system having a viscosifier in an amount of 40 PPT in sea water. The viscosifying agent is CMHPG. Additional additives are a low pH buffer, in particular 0.2 gallons per thousand (“GPT”) of an aluminum acetate and acetic acid blend and 0.35 GPT of zirconium lactate in an isopropyl alcohol as a cross-linker. In this chart the amount and types polyols are varied. Line 100 charts the fluid temperature over the duration of the test. Line 102 is the shear rate of the fluid having 10.0 GPT of the polyol, propylene glycol, over time. Line 104 is the shear rate of the fluid having no added polyol over time. Line 106 is the shear rate of the fluid having 7.5 GPT of added polyol, propylene glycol, over time. Line 108 is the shear rate of the fluid having 10.0 GPT of added polyol, ethylene glycol, over time. Line 112 is the shear rate of the fluid having 10.0 GPT of added polyol, methyl ethyl ketone, over time. Line 114 is the shear rate of the fluid having 10.0 GPT of added polyol, methanol, over time. Line 110 is the shear rate of the test over time. As can be seen the fluid having the ketone, methyl ethyl ketone, maintained a viscosity of greater than 50 centipoise for the least amount of time, about 47 minutes. The fluid having 10.0 GPT of polyol, propylene glycol, maintained a viscosity of greater than 50 centipoise for the longest amount of time, about 130 minutes. The other polyols or reduced amount of propylene glycol had degraded performance when compared to propylene glycol but performed better than no polyol in the fluid.

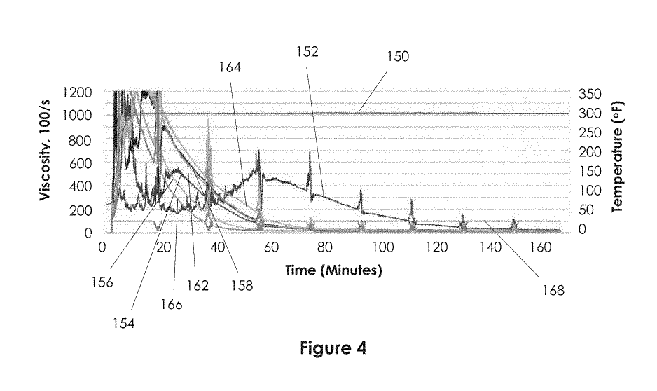

FIG. 4 depicts the rheological profile of a fracturing fluid system having a viscosifier in an amount of 40 PPT in sea water. The viscosifying agent is CMHPG. Additional additives are a low pH buffer, in particular 0.2 gallons per thousand (“GPT”) of an aluminum acetate and acetic acid blend and 0.35 GPT of zirconium lactate in an isopropyl alcohol as a cross-linker. In this chart the amount and types polyols are varied. Line 150 charts the fluid temperature over the duration of the test. Line 152 is the shear rate of the fluid having 10.0 GPT of the polyol, propylene glycol, over time. Line 154 is the shear rate of the fluid having no added polyol over time. Line 156 is the shear rate of the fluid having 1.0 PPT of added polyol, xylitol, over time. Line 158 is the shear rate of the fluid having 1.0 PPT of added polyol, meso-erythritol, over time. Line 162 is the shear rate of the fluid having 1.0 PPT of added polyol, d-manitol, over time. Line 164 is the shear rate of the fluid having 1.0 PPT of added polyol, inositol, over time. Line 166 is the shear rate of the fluid having 1.0 PPT of added polyol, d-sorbitol, over time. Line 168 is the shear rate of the test over time. As can be seen the sugars inositol, meso-erythritol, and d-manitol were slightly better than no viscosity stabilizer at maintaining the viscosity of the fluid above 50 centipoise while the sugars xylitol, and d-sorbitol decreased the ability of the fluid to maintain a viscosity of greater that 50 centipoise.

In addition to the embodiments described above, the hydraulic fracturing fluid additives described above may also be included in the treatment chemistry. This list of additives is not exhaustive and additional additives known to those skilled in the art that are not specifically cited below fall within the scope of the invention

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

1. A well treatment material comprising:
a salt water,
a viscosifying agent, and
a polyol.

2. The well treatment material of claim 1 further comprising:
a cross-linker.

3. The well treatment material of claim 2 further comprising:
a low pH buffer.

4. The well treatment material of claim 1 wherein, the salt water is seawater.

5. The well treatment material of claim 1 wherein, the salt water is brine.

6. The well treatment material of claim 1 wherein, the salt water is produced water.

7. The well treatment material of claim 1 wherein, the viscosifying agent is a guar and its derivatives.

8. The well treatment material of claim 1 wherein, the viscosifying agent is a cellulose and its derivatives.

9. The well treatment material of claim 1 wherein, the viscosifying agent is an poly-acrylamide and its derivatives.

10. The well treatment material of claim 1 wherein, the polyol is a propylene glycol.

11. The well treatment material of claim 10 wherein, the propylene glycol is present in an amount of 10 GPT.

12. The well treatment material of claim 10 wherein, the propylene glycol is present in an amount from 7.5 GPT to 25 GPT.

13. The well treatment material of claim 10 wherein, the propylene glycol is present in an amount from 0.5 GPT to 50 GPT

14. The well treatment material of claim 1 wherein, the polyol is a sugar chosen from the group consisting of inositol, meso-erythritol, and d-manitol.

15. The well treatment material of claim 1 wherein, the polyol is ethylene glycol.

16. The well treatment material of claim 1 wherein, the polyol is methanol.

17. A method of stabilizing a viscosifier in a high-temperature well comprising:
mixing a fluid having a salt water, a viscosifying agent, and a polyol, and pumping the fluid into a well having a downhole temperature above 260° F.

18. The method of claim 17 further comprising:
a cross-linker.

19. The method of claim 18 further comprising:
a low pH buffer.

20. The method of claim 17 wherein, the salt water is seawater.

21. The method of claim 17 wherein, the salt water is brine.

22. The method of claim 17 wherein, the salt water is produced water.

23. The method of claim 17 wherein, the viscosifying agent is guar and its derivatives.

24. The method of claim 17 wherein, the viscosifying agent is a cellulose and its derivatives.

25. The method of claim 17 wherein, the viscosifying agent is an poly-acrylamide and its derivatives

26. The method of claim 17 wherein, the polyol is a propylene glycol.

27. The method of claim 26 wherein, the propylene glycol is present in an amount of 10 GPT.

28. The method of claim 26 wherein, the propylene glycol is present in an amount from 7.5 GPT to 25 GPT.

29. The method of claim 26 wherein, the propylene glycol is present in an amount from 0.5 GPT to 50 GPT

30. The method of claim 17 wherein, the polyol is a sugar chosen from the group consisting of inositol, meso-erythritol, and d-manitol.

31. The method of claim 17 wherein, the polyol is ethylene glycol.

32. The method of claim 17 wherein, the polyol is methanol.
